(19) United States
(12) Patent Application Publication
(10) Pub. No.: US 2008/0084559 A1
(43) Pub. Date: Apr. 10, 2008

(54) Microvolume sampling device

(75) Inventors: Craig D. Harrison, Basking Ridge, NJ (US); Mark C. Salerno, Cranford, NJ (US); I-Tsung Shih, Basking Ridge, NJ (US)

Correspondence Address: MCCARTER & ENGLISH, LLP, FOUR GATEWAY CENTER, 100 MULBERRY STREET, NEWARK, NJ, 07102, US

(73) Assignee: C Technologies, Inc.

(21) Appl. No.: 11/973,854

(22) Filed: Oct. 10, 2007

Related U.S. Application Data
(60) Provisional application No. 60/850,585, filed on Oct. 10, 2006.

(51) Int. Cl. G01J 3/00; G01N 1/10

(52) U.S. Cl. 356/300; 356/246; 73/864.91

(57) ABSTRACT

Disclosed herein is a microvolume sampling device that includes a chip and a UV-transmissive cell formed of fused silica. The chip has a plurality of wells, a receiving area extending therebetween, and a port extending through the chip to the receiving area. The cell, which preferably has a rectangular cross-section, is securingly positioned within the receiving area and extends into the wells. A chamber is defined by the cell, and a fluid sample can be drawn into the chamber from at least one of the wells by capillary force. The microvolume sampling device can be disposed upon a tray having an opening such that the port of the microvolume sampling device is in alignment with the opening to define an optical path for spectroscopic measurement of the fluid sample. The tray can be provided as a well plate for receiving a plurality of microvolume sampling devices.

### CROSS-REFERENCE TO RELATED APPLICATIONS

The present application claims the benefit of U.S. Provisional Application No. 60/850,585, filed Oct. 10, 2006, which is hereby incorporated by reference in its entirety for all purposes.

### FIELD OF THE INVENTION

The present invention relates generally to a sampling device, and, more particularly, a sampling device that facilitates spectroscopic measurements of small volumes of liquid.

### BACKGROUND OF THE INVENTION

Spectroscopic measurements of solutions are widely utilized in various fields, where the move to measuring smaller volumes is becoming more and more common as the cost of solutions increases. Factors contributing to these issues stem from the expense and time associated with creating or preparing the solutions for testing, as well as the inherent limitations of samples, such as proteins, stem cells, DNA/RNA, and pharmacological preparations. However, the desire for more samples, tests, statistics, data, etc. has created a strong move toward using smaller volumes of sample in assays and experiments.

Existing technologies, such as sample cuvettes, can require relatively large amounts of sample solution to allow measurement, e.g., about fifty to one hundred microlitres. Other existing technologies, bring the risk of carryover which can contaminate the measurement area and result in incorrect data and require cleaning between measurements. Some existing options for measuring small volumes can only be used to measure limited wavelength regions due to the materials used to fabricate such devices. Further, tolerance in the path length, i.e., the distance that defines the measurement zone and the amount of material being measured, can introduce more variation into the measurement results.

It is, however, known in the art to provide a device for analyzing a small volume of liquid, e.g., less than five microlitres. What is needed in the art, however, is a device that provides low cost, disposability, accurate path length, and facilitates spectroscopic measurements of small volumes of liquid while permitting existing dispensing equipment to fill the device with small samples of liquid.

### SUMMARY OF THE INVENTION

The present invention overcomes the disadvantages and shortcomings of the prior art by providing a microvolume sampling device for spectroscopic measurements of a liquid sample. The microvolume sampling device includes a chip that supports a transparent cell preferably formed from a material with fused silica and preferably having a rectangular cross-section that provides a controlled, accurate path length. The chip includes a plurality of wells, a receiving area formed therebetween, and a central opening extending from a lower, outer surface of the chip through to the receiving area. The transparent cell is positioned within the receiving area and is aligned with the central opening. The ends of the cell are proximate the wells in the chip.

A chamber is formed within the transparent cell that has a preferred volume in the range of about one (1) to about five (5) microlitres. However, the chamber can have any volume suitable for the present invention, including volumes less than about (1) microlitre and/or greater than about five (5) microlitres. The transparent cell is preferably UV-transmissive for wavelengths of about one-hundred ninety (190) nanometers and upward. However, the transparent cell can be transparent for light of any suitable wavelength, such as visible light, infrared, near infrared, etc.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a perspective view showing a microvolume sampling device constructed in accordance with an exemplary embodiment of the present invention;

FIG. 2 is a cross-sectional view taken along section line 2-2 of the microvolume sampling device of FIG. 1;

FIG. 3 is a cross-sectional view taken along section line 3-3 of the microvolume sampling device of FIG. 1;

FIG. 4 is a perspective view of the microvolume sampling device of FIG. 1 in combination with a detector for facilitating spectroscopic measurement of a liquid sample contained by the microvolume sampling device;

FIG. 5 is perspective view of a well plate for supporting a plurality of microvolume sampling devices during spectroscopic measurement of a plurality of liquid samples contained thereby; and

FIG. 6 is perspective view of the well plate of FIG. 5 in combination with a plurality of microvolume sampling devices.

### DETAILED DESCRIPTION OF THE EXEMPLARY EMBODIMENT

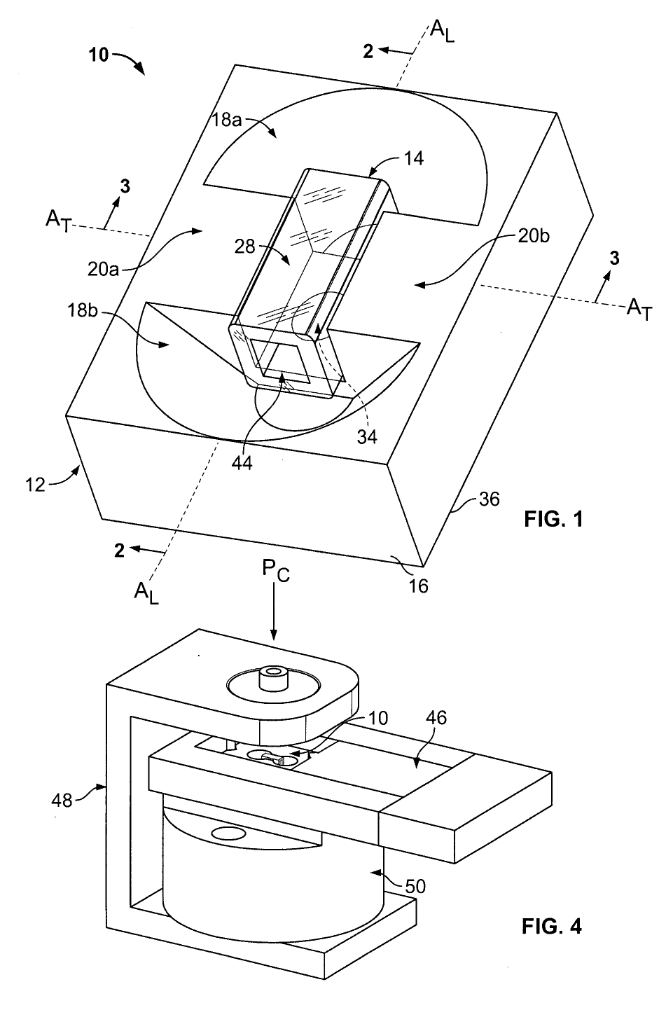

Referring to FIGS. 1-3, a microvolume sampling device 10 constructed in accordance with the invention is shown. The microvolume sampling device 10 includes a chip 12 and a cell 14 supported by the chip 12. The chip 12 and the cell 14 shall each be discussed in further detail below.

The chip 12 preferably includes a solid block 16 that has a generally rectangular shape, although the shape can be varied if desired. The chip 12 is preferably formed from plastic, but it is contemplated that the chip 12 can be formed from any suitable material known in the art. It is further contemplated that the chip 12 can be thermally controlled, such as for applications in which kinetic information and thermally controlled testing is preferred.

A plurality of wells 18a, 18b are formed in the block 16 symmetrically along a central longitudinal axis A_{L} of the chip 12. A plurality of walls 20a, 20b are formed in the block 16 along a central transverse axis A_{T} of the chip 12, and the wells 18a, 18b are spaced apart from the central transverse axis A_{T} by the walls 20a, 20b.

The shape of the wells 18a, 18b as herein shown and described is exemplary to facilitate consideration and discussion of the microvolume sampling device 10. However, it is contemplated that each one of the wells 18a, 18b can have any suitable shape. In selecting the shape of the wells 18a, 18b, it is preferred that at least one of the wells 18a, 18b be of an appropriate shape (and size) to allow for a desired volume of liquid to be transferred into the chamber of the cell 14, which is further discussed below. The shape (and size) of at least one of the wells 18a, 18b is preferably small enough to keep the chip 12 compact, while preferably being large enough to facilitate passage of a fluid sample into a chamber of the cell 14, such as by capillary action and/or other forces.

In one example, the well 18a is tapered at a lower elevation thereof and has a shape that may be characterized as an inverted hemi-frustum. More particularly, the well 18a is at least partially defined by a generally vertical surface 22a, a partially frustoconical surface 24a extending at two ends thereof to the generally vertical surface 22a, and a floor 26a that intersects the partially frustoconical surface 24a and that perpendicularly intersects the generally vertical surface 22a. It shall be understood that the well 18b is preferably a mirror image of the well 18a and that the exemplary well 18b is at least partially defined by a generally vertical surface 22b, a partially frustoconical surface 24b, and a floor 26b.

Continuing with reference to FIGS. 1-3, the walls 20a, 20b are spaced equidistantly from the central longitudinal axis A_{L} by a gap, which is referenced herein as a receiving area 28. The receiving area 28 is defined by a plurality of planar surfaces formed in the walls 20a, 20b that are referenced herein as gripping surfaces 30a, 30b. The receiving area 28 is further defined by a planar surface, referenced herein as a seat 32, which extends perpendicularly between the gripping surfaces 30a, 30b. The seat 32 preferably extends parallel to the floors 26a, 26b and at an elevation higher than that of the floors 26a, 26b. A bore, which is referenced herein as a port 34, extends through the block 16 from an outer surface 36 thereof to the seat 32. The port 34 is preferably formed centrally in the block 16, e.g., in alignment with the intersection of the central longitudinal axis A_{L} and the central transverse axis A_{T}, and substantially perpendicular to both axes A_{L}, A_{T}. It is contemplated that one or more additional and/or alternative ports can be provided. For example, another port can be provided through the outer surface 36 alongside port 34. Ports can also be provided in alignment with the central transverse axis A_{T}, such that the port extends through at least one of the walls 20a, 20b perpendicularly with respect to the vertical surfaces 22a, 22b.

The cell 14 of the microvolume sampling device 10 is positioned within the receiving area 28 and extends at least partially into each one of the wells 18a, 18b. The cell 14 has a ceiling 38, a floor 40, and a plurality of sidewalls 42a, 42b, which form a rectangular shaped cross-section. As shown in FIG. 3, the rectangular shaped cross-section can be a square cross-section. Other cross-sections can be utilized, but preferably the ceiling 38 and the floor 40 are parallel with one another to reduce complexity in evaluating the light passing through the ceiling 38, the floor 40, and a fluid sample therebetween to evaluate the fluid sample.

The cell 14 can be secured within the receiving area 28 by any suitable means, including by a friction-fit formed between the sidewalls 42a, 42b and the gripping surfaces 30a, 30b. The floor 40 of the cell 14 preferably abuts against the seat 32 in alignment with the port 34. The cell 14 defines a chamber 44 therein, which is preferably sized to contain a microvolume of fluid, and which is more preferably sized to contain a volume in the range of about one (1) to five (5) microlitres. However, the chamber can have any volume suitable for the present invention, including volumes less than about (1) microlitre and/or greater than about five (5) microlitres.

The cell 14, including the ceiling 38 and the floor 40 thereof, is formed from a material with fused silica, e.g., glass. It is contemplated, however, that the cell 14 can be formed of any suitable transparent material, such as plastic. The cell 14 is preferably transmissive of ultraviolet (UV) light and, more preferably, is UV-transmissive for wavelengths of about one hundred ninety (190) nanometers and upward. As indicated above, however, the transparent cell can be transparent for light of any suitable wavelength, such as visible light, near infrared, etc.

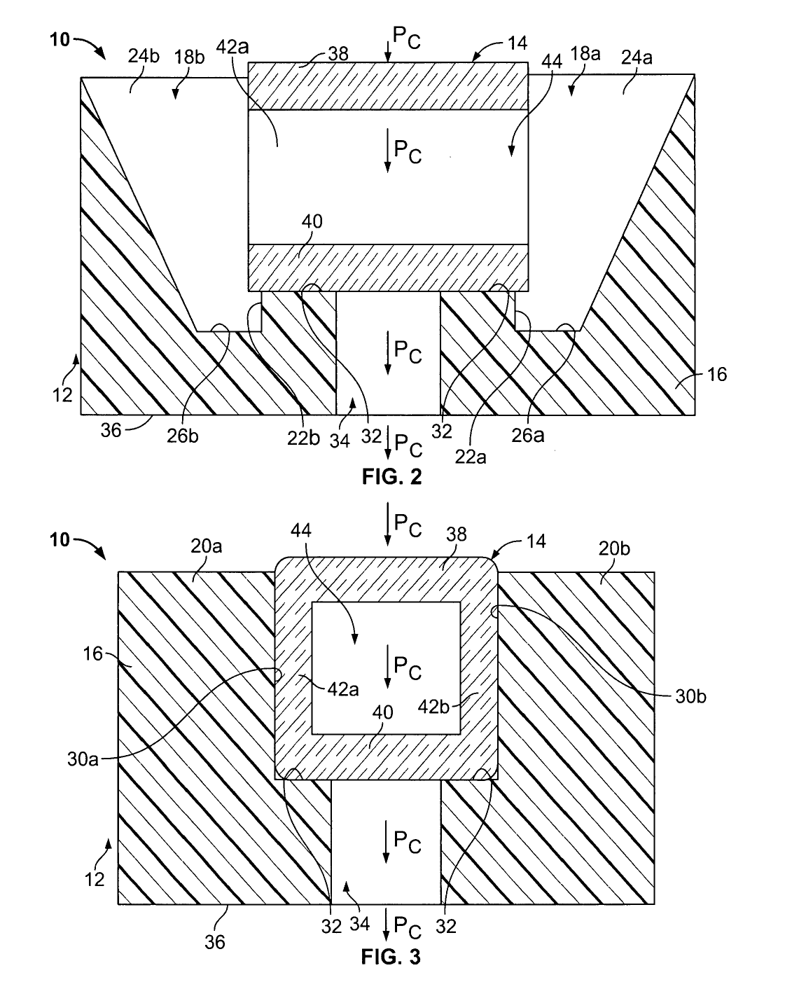

Light can thus travel through the cell 12 and the port 34 along an optical path P_{c}, which is designated in FIGS. 2-4. The cell 14 provides a controlled accurate pathlength through which light travels. It is contemplated the cell 14 can include a coating, such as an optical filter, for controlling the optical properties of the cell 14 (not shown). It is further contemplated that a chemical coating can be deposited on the cell 14 (and/or the chip 12) for reacting with the deposited fluid samples and the associated measurements.

Referring to FIGS. 1 and 4, a contemplated use of the microvolume sampling device 10 shall now be discussed. Fluid is dispensed into the chamber 44 by positioning a conventional fluid source adjacent the chamber 44 at one of the wells 18a, 18b. More particularly, fluid is directly dispensed into one or more of the wells 18a, 18b, or directly into the cell 14, and the capillary force of the ceiling 38, the floor 40, the sidewall 42a, and/or the sidewall 42b draw the fluid into the chamber 44. It is contemplated that additional forces (and/or alternative forces) can be utilized to receive the fluid sample into the chamber 44, e.g., fluid can be dispensed directly into the chamber 44.

The microvolume sampling device 10 is used in connection with suitable equipment known in the art for spectroscopic measurement of the fluid. For example, as shown in FIG. 4, the microvolume sampling device 10 can be disposed on a tray 46 that has an opening (not shown) in alignment with the port 34 of the chip 12. The tray 46 is at least temporarily secured to a mounting assembly 48, such that the port 34 of the chip 12 and the opening in the tray 46 are in alignment with one another and with an optical detector 50. In this regard, an ultraviolet emitter (not shown) can transmit ultraviolet light along the path P_{c} through the cell ceiling 38, the fluid in the chamber 44, the cell floor 40, the port 34 of the chip 12, and the opening in the tray 46, such that the optical detector 50 receives the emitted light (as such light had been modified by the optical properties of the fluid) for spectroscopic measurement of the fluid. An emitter and detector can be provided that are configured to respectively emit and detect light of any suitable wavelength.

As indicated above, it is contemplated that one or more additional (or alternative) ports can be provided. In such circumstances, it is contemplated that one or more additional (or alternative) detectors can be utilized in connection with the microvolume sampling device 10, such that each detector is in alignment with a port corresponding thereto.

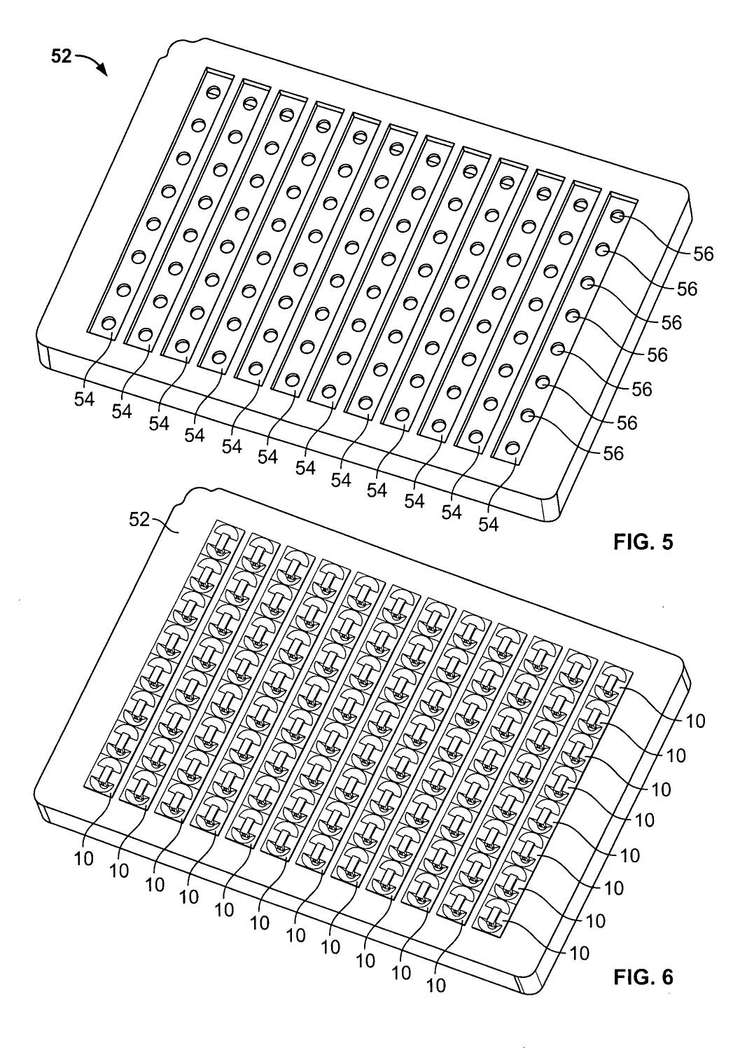

Referring to FIGS. 5 and 6, it is contemplated that a plurality of the microvolume sampling devices 10 can used in combination with one another for the efficient measurement of a plurality of fluid samples. For example, a well plate 52 can be provided with a plurality of channels 54, each for receiving a plurality of the microvolume sampling devices 10. Each one of the channels 54 has a plurality of openings 56, and the port 34 of each one of the microvolume sampling devices 10 is alignable with one of the openings 56. A radio frequency identification transponder (RFID tag) can be secured to each chip 12 for tracking purposes, and a computer-based RFID tracking system can be used to store information communicated to the tracking system by the transponder.

The microvolume sampling device 10 facilitates precise spectroscopic measurements of small volumes of liquid solutions with existing spectroscopic laboratory equipment. The microvolume sampling device 10 is preferably disposable and hence avoids cleaning and carryover issues. Methods for dispensing controlled small volumes of liquid existing and can be used, without any substantial adaptation to the microvolume sampling device 10.

It will be understood that the embodiments of the present invention described herein are merely exemplary and that a person skilled in the art may make many variations and modifications without departing from the spirit and scope of the invention. All such variations and modifications, including those discussed above, are intended to be included within the scope of the invention as defined in the appended claims.

What is claimed is:

1. A microvolume sampling device, comprising:
a chip having defined therein a well, a receiving area extending from said well, and a port extending through an outer surface of said chip to said receiving area; and
a transparent cell positioned at least partially within said receiving area, said transparent cell defining therein a chamber in alignment with said port and including an end sized and positioned to receive a fluid sample in said chamber.

2. The device of claim 1, wherein said cell has a rectangular cross-section.

3. The device of claim 1, wherein said end of said transparent cell extends to said well.

4. The device of claim 1, wherein said transparent cell is formed of a UV-transmissive material.

5. The device of claim 4, wherein said transparent cell is UV-transmissive for wavelengths of at least about one hundred ninety nanometers.

6. The device of claim 1, wherein a volume of said chamber is about one microlitre to about five microlitres.

7. The device of claim 1, including a second port extending through said chip to said receiving area.

8. The device of claim 1, including at least one of a first coating for reacting chemically with the fluid sample and a second coating for providing an optical filter.

9. The device of claim 1, wherein said chip has defined therein a second well and said receiving area extends from said well to said second well, and wherein said transparent cell includes a second end sized and positioned to receive the fluid sample from said second well into said chamber.

10. The device of claim 1 in combination with a tray for receiving said chip, said tray having an opening configured to be, in use, aligned with said port of said transparent cell.

11. A microvolume sampling device, comprising:
a chip having defined therein a first well and a second well, a receiving area extending from said first well to said second well, and a port extending through an outer surface of said chip to said receiving area; and
a UV-transmissive cell of rectangular cross-section positioned at least partially within said receiving area and forming a secure fit with said chip, said UV-transmissive cell defining therein a chamber in alignment with said port and having a first end extending to said first well and a second end extending to said second well, said UV-transmissive cell configured to draw a fluid sample into said chamber from at least one of said wells.

12. The device of claim 11, wherein said UV-transmissive cell is UV-transmissive for wavelengths of at least about one hundred ninety nanometers.

13. The device of claim 11, wherein a volume of said chamber is about one microlitre to about five microlitres.

14. A system for sampling a plurality of fluid microvolume samples, comprising:
a plurality of microvolume sampling devices, each of said microvolume sampling devices including a chip having defined therein a well, a receiving area extending from said well, and a port extending through an outer surface of said chip to said receiving area, and each of said microvolume sampling devices further including a transparent cell positioned adjacent said port and at least partially within said receiving area, said transparent cell defining therein a chamber and having an end sized and positioned to receive a fluid sample into said chamber; and
a well plate including a plurality of channels configured to receive said plurality of microvolume sampling devices and further including a plurality of openings extending from said channels to an outer surface of said well plate opposite said channels and positioned for alignment with each port of said plurality of microvolume sampling devices.

15. The system of claim 14, including a kit having said well plate and said plurality of microvolume sampling devices unassembled therewith.

16. The system of claim 14, wherein each of said plurality of channels is configured to receive at least two of said plurality of microvolume sampling devices, and wherein each of said plurality of channels has at least two of said plurality of openings extending thereto.

17. The system of claim 14, wherein a volume of said chamber is about one microlitre to about five microlitres.

18. The system of claim 14, wherein said chip has defined therein a second well and said receiving area extends from said well to said second well, and wherein said transparent cell includes a second end sized and positioned to receive a fluid sample from said second well into said chamber.

19. The system of claim 14, including a plurality of radio frequency identification transponders for tracking of each of the plurality of microvolume sampling devices.

20. A method of spectroscopic measurement of at least one microvolume fluid sample, comprising:
providing a microvolume sampling device including a chip having defined therein a well, a receiving area extending from the well, and a port extending through an outer surface of the chip to the receiving area, and further including a transparent cell positioned at least partially within the receiving area, the transparent cell defining therein a chamber in alignment with the port and including an end sized and positioned to receive a fluid sample from the well into the chamber;
dispensing the fluid sample into the well; and
allowing the fluid sample to be drawn into the chamber.

21. The method of claim 20, including emitting light along an optical path through the transparent cell, the drawn fluid sample, and the port, and further including detecting the light proximal a side of the port opposite the transparent cell.

22. The method of claim 21, including taking a spectroscopic measurement of the drawn fluid sample based on the detected light.

23. The method of claim 20, including disposing the microvolume sampling device on a tray with the port in alignment with an opening formed in the tray.

24. The method of claim 23, including at least temporarily securing the tray to a mounting assembly associated with an emitter and a detector.

25. The method of claim 24, including:
emitting light from the emitter along an optical path through the transparent cell, the drawn fluid sample, the port, and the opening of the tray;
receiving the light at a detector positioned at a side of the opening opposite the transparent cell; and
taking a spectroscopic measurement of the drawn fluid sample based on the detected light.
